(19) United States
(12) Patent Application Publication
(10) Pub. No.: US 2008/0144038 A1
(43) Pub. Date: Jun. 19, 2008

(54) PERFORMANCE AND ACCURACY ASSESSMENT SYSTEM FOR REFRACTIVE LASER SYSTEMS AND ASSOCIATED METHODS

(76) Inventors: Richard Alan LeBlanc, Clermont, FL (US); Martin Sensiper, (US); Phuoc Khanh Nguyen, Winter Springs, FL (US)

Correspondence Address: ALCON, IP LEGAL, TB4-8, 6201 SOUTH FREEWAY, FORT WORTH, TX, 76134, US

(21) Appl. No.: 11/612,721

(22) Filed: Dec. 19, 2006

(51) Int. Cl. G01N 21/55

(52) U.S. Cl. 356/448

(57) ABSTRACT

A method for assessing a performance of a laser system for use in corneal ablation is provided that includes directing a beam of laser shots onto a fluorescent indicator. The indicator is adapted to emit a first wavelength of light different from a second wavelength of light impinging thereon. The directing step is performed in a plane of a cornea of an eye desired to be ablated and also onto a cornea positioned at the corneal plane. Light reflected from the indicator is detected, and a difference between a detected light pattern from the camera and a predetermined ablation pattern desired to be made on the cornea is calculated. The predetermined pattern is then corrected to compensate for the calculated difference.

### FIELD OF INVENTION

The present invention generally relates to ophthalmic laser surgery and, in particular, to systems and methods for assessing system component performance, and, most particularly, to systems and methods for assessing the performance and accuracy of a refractive laser system.

### BACKGROUND

Ophthalmic surgery for the correction of vision is known to be performed with lasers, for example, excimer lasers, that are used to ablate the cornea in a predetermined pattern. The laser is applied in bursts of energy, referred to as shots, each of which has physical and temporal characteristics that must be known precisely in order that the predetermined pattern be commensurate with the pattern ablated by the laser. Further, the optical system that directs the shots to the cornea also has physical characteristics that must be precisely calibrated in order that the shots be placed correctly.

Currently known methods for assessing laser system performance are typically not performed during surgery, and instead laser statistics are monitored during calibration. Such calibration can include the use of disposable physical materials that are ablated, with geometric correction and ablation calibration based upon physical impressions left on the physical materials, which are subjectively analyzed by the user. Optical components are replaced when the uniformity of the laser energy across the field becomes unacceptable. At present, typically a 10% variation triggers replacement, and this level can be considered unacceptable in some systems.

Existing methods try to maintain pulse-to-pulse uniformity, which requires a great deal of calibration and testing, limiting the number of surgeries that can be performed, and demanding frequent changing of optical components. Further, the laser must often be purged of its gas, owing to the amount of testing and the requirement for constant power.

Therefore, it would be desirable to provide a method for assessing the performance of a refractive laser system that is accurate and automated and eliminates or reduces the above problems associated with prior art refractive laser systems.

### SUMMARY OF THE INVENTION

A method for assessing a performance of a laser system for use in corneal ablation is provided, wherein the method comprises the step of directing a beam of laser shots onto a fluorescent indicator. The indicator is adapted to emit a first wavelength of light different from a second wavelength of light impinging thereon. The directing step is performed in a plane of a cornea of an eye desired to be ablated and also onto a cornea positioned at the corneal plane.

Light reflected from the indicator is detected (e.g., at a camera), and a difference between a detected light pattern from the camera and a predetermined ablation pattern desired to be made on the cornea is calculated. The predetermined pattern is then corrected to compensate for the calculated difference.

One embodiment of the system for assessing a performance of a laser system for use in corneal ablation according to the present invention comprises a fluorescent indicator that is adapted to emit a first wavelength of light different from a second wavelength of light impinging thereon. An optical system operates to direct a beam of laser shots onto the indicator in a plane of a cornea of an eye desired to be ablated and also onto a cornea positioned at the corneal plane.

A camera is positioned to detect light reflected from the indicator. An analyzer in signal communication with the camera is provided for calculating a difference between a detected light pattern from the camera and a predetermined ablation pattern desired to be made on the cornea. The analyzer is also provided for correcting the predetermined pattern to compensate for the calculated difference.

The features that characterize the embodiments of this invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWING

FIG. 1 is a schematic of an embodiment of the system of the present invention;

FIG. 2 is a side perspective view of a monitoring fixture according to the present invention;

FIG. 3 is a flow diagram of an exemplary embodiment of the method of the present invention;

FIG. 4 is a camera image of an exemplary grid of laser pulses;

FIG. 5 is an exemplary grid of an input laser pattern versus observed centroids;

FIG. 6 illustrates a user being able to select a particular shot for analysis according to one embodiment of the present invention;

FIG. 7 illustrates a three-dimensional display of the selected shot from FIG. 7, along with a calculation of the shot volume;

FIG. 8 is a three-dimensional view of an average of 20 laser pulses;

FIG. 9 is a graph of the movement of individual centroids from the mean;

FIG. 10 is a graph of normalized volume for a system with a known lower-energy location; and

FIGS. 11A-11E indicate steps in an embodiment of a method for centering laser shots according to the present invention: FIG. 11A indicates the input pattern; FIG. 11B, image collection; FIG. 11C, the summation of the laser spots; FIG. 11D, plotting of the centroids; and FIG. 11E, translation and rotation of centroids.

### DETAILED DESCRIPTION OF THE INVENTION

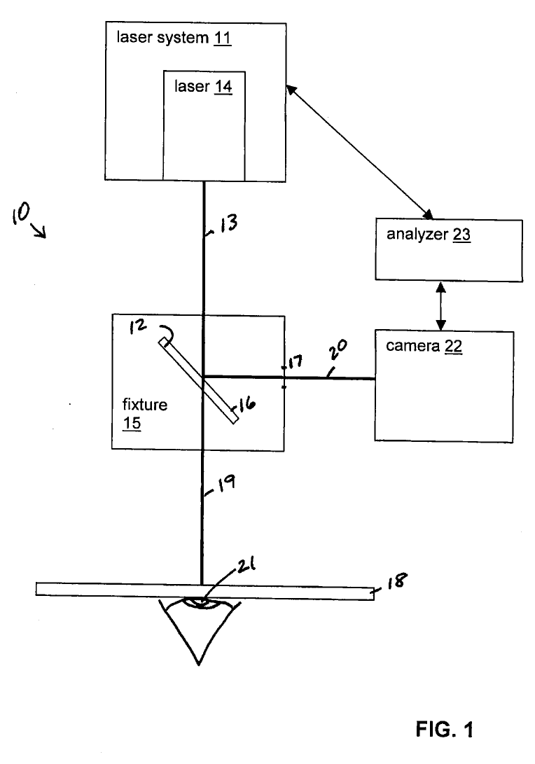

A description of various embodiments of the present invention will now be presented with reference to FIGS. 1-11E.

A system 10 (FIG. 1) for assessing a performance of a laser system 11 is provided for use in corneal ablation, for example. The system 10 comprises a fluorescent indicator 12 that is adapted to emit a first wavelength of light different from a second wavelength of light impinging thereon. A beam 13 from a laser 14 in the laser system 11 is directed via optics to an exemplary embodiment of a fixture 15 for supporting the indicator 12. One embodiment of fixture 15 which comprises a 45-degree, partially reflecting surface 16 and a fluorescent window 17 is shown in more detail in FIG. 2. The partial mirror 16 can comprise ultraviolet (uv) glass, which allows ablation to take place at the eye plane 18 with the transmitted beam 19 while monitoring reflected light 20. The optical system thus operates to direct a beam 13 of laser shots onto the indicator 12/16 in a plane of a cornea of an eye desired to be ablated and also onto a cornea 21 positioned at the corneal plane, both the through-beam 19 and the reflected beam 20 impinging on their respective planes with substantially normal incidence.

A camera 22 is positioned to detect the light 20 reflected from the indicator. An analyzer 23 in signal communication with the camera 22 is provided for calculating a difference between a detected light pattern from the camera 22 and a predetermined ablation pattern desired to be made on the cornea 21. The analyzer 23 is also provided for correcting the predetermined pattern to compensate for the calculated difference. Preferably the camera 22 and the analyzer 23 are adapted to operate faster than a shot rate of the laser 14.

In a particular embodiment, the camera 22 has asynchronous and synchronous modes. The asynchronous mode synchronizes to an external input for the start of frame. The integration time is set by an internal register/timing. The maximum frame rate is approximately 50 Hz. If the synch signal exceeds the maximum frame rate, the camera waits for the next synch. An existing laser pretrigger pulse for the system gives adequate time for camera reset. As shown by Table 1, the duty cycle can be determined by the laser pulse rate and the pulse capture rate.

TABLE 1
Duty Cycle as a Function of Laser Pulse Rate and Pulse Capture Rate

| Laser Pulse Rate (Hz) | Pulse Capture Rate (Hz) | Duty Cycle |
|---|---|---|
| 30 | 30 | 30 |
| 45 | 45 | 1 |
| 60 | 30 | ½ |
| 80 | 40 | ½ |
| 105 | 35 | ⅓ |

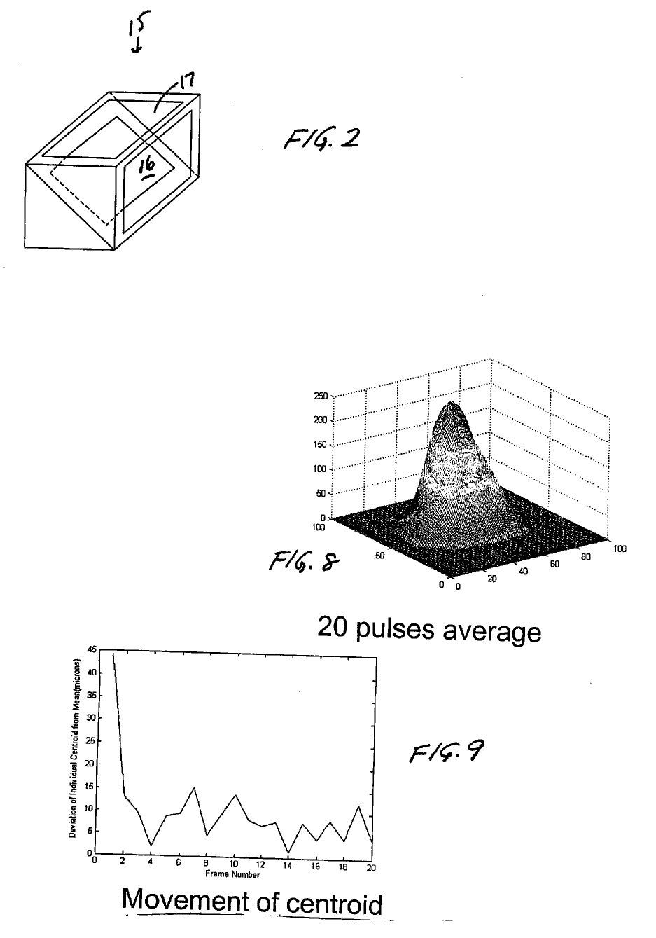

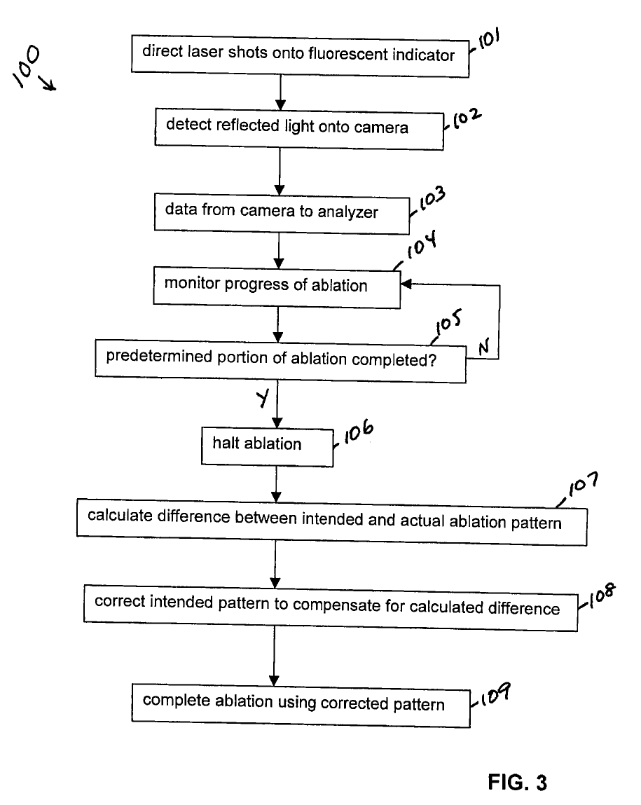

A method 100 for assessing a performance of a laser system for use in corneal ablation includes directing a beam of laser shots onto a fluorescent indicator 12 as above (block 101; FIG. 3). Light reflected from the indicator 12 is detected by the camera 22 (block 102) at a rate faster than a shot rate of the laser 14.

The camera 22 sends data to an analyzer 23 (block 103), where a difference between a detected light pattern from the camera and a predetermined ablation pattern desired to be made on the cornea is calculated. The analyzer 23 can then correct the predetermined pattern to compensate for the calculated difference.

In a particular embodiment of a method for carrying out a corneal ablation, the progress of the creation of the predetermined pattern is monitored (block 104). When a predetermined portion of the predetermined pattern has been completed (block 105), the ablation is halted (block 106), and the difference between the portion of the predetermined pattern that has been completed and the detected light pattern is calculated (block 107). Then the remaining portion of the predetermined pattern is corrected to make up for the difference (block 108), and the ablation pattern is completed (block 109).

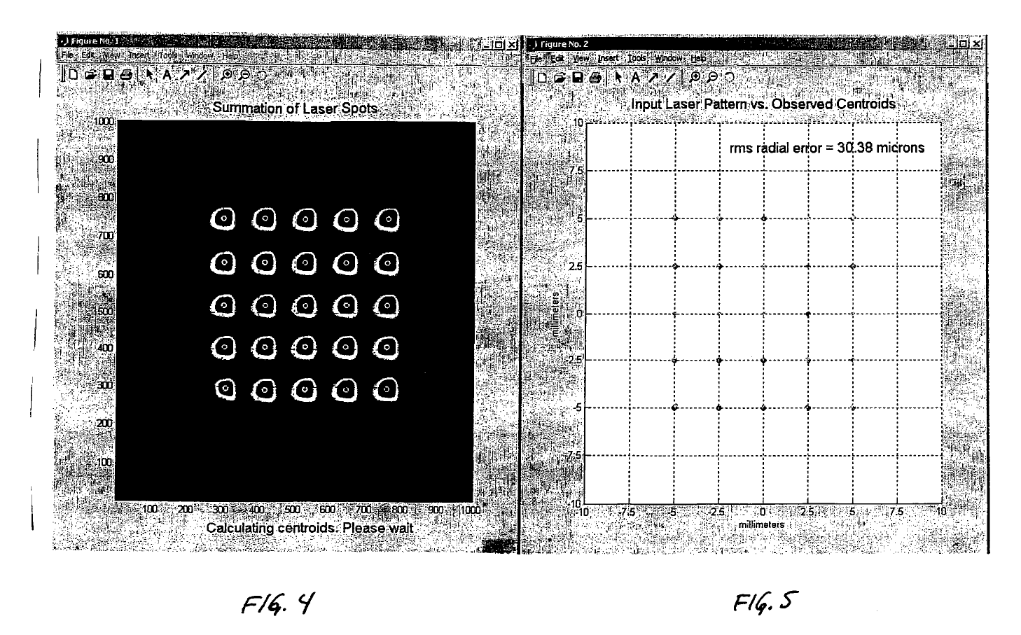

In FIG. 4 is depicted an exemplary camera image of a grid of laser pulses, and in FIG. 5, a display of the input laser pattern versus the observed centroids calculated from the data of FIG. 4. The shots, which are intended to be placed at the intersection of the grid lines, can be seen to deviate slightly from their desired positions, and an rms radial error of 30.38 μm is found.

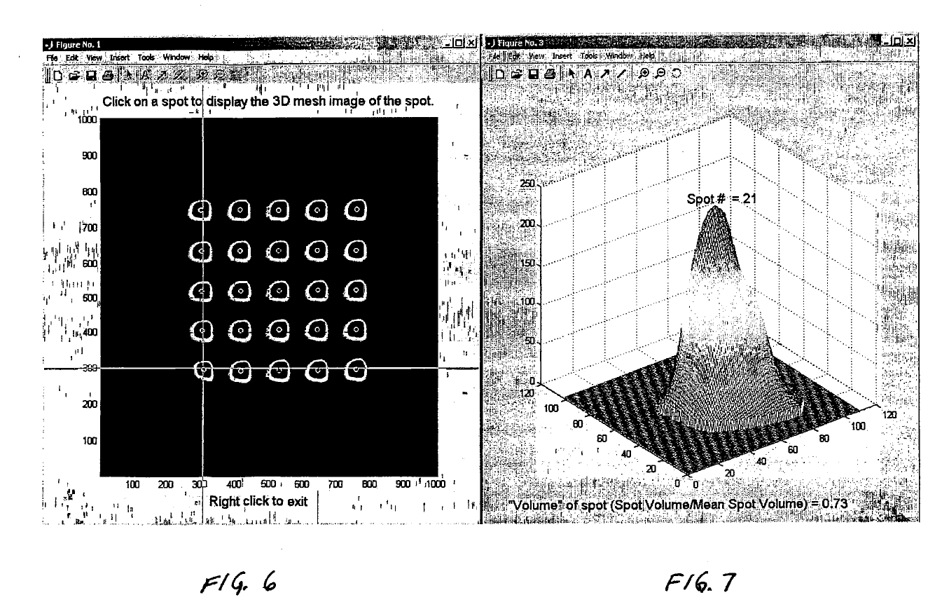

FIG. 6 illustrates a user being able to select a particular shot for analysis on a display screen of a matrix of shots. FIG. 7 illustrates a three-dimensional display of the selected shot from FIG. 6, along with a calculation of the shot volume. FIG. 8 is a three-dimensional view of an average of 20 laser pulses, and FIG. 9 is a graph of the movement of individual centroids from the mean.

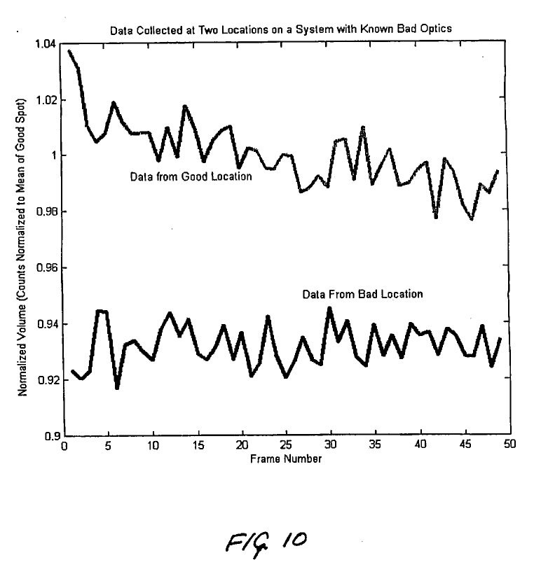

The performance of a laser system can be estimated using the system 10 and method 100 of the present invention. As an experiment, a system with known bad optics at a particular location was measured to have a variation of 7% using an energy meter, which correlates well with a measurement using the present system of 93% of the energy at the less efficient location. The experiment was performed by collecting 50 sequential frames of data at a “good” spot and a “bad” spot (FIG. 10). The volume is found by summing the pixel values, and the volumes are normalized to the mean volume at the good spot. The mean value at the bad spot is 93% of the mean value at the good spot, with a standard deviation of the mean at the good spot of ˜1.2% and a standard deviation of the mean at the bad spot of ˜0.7%.

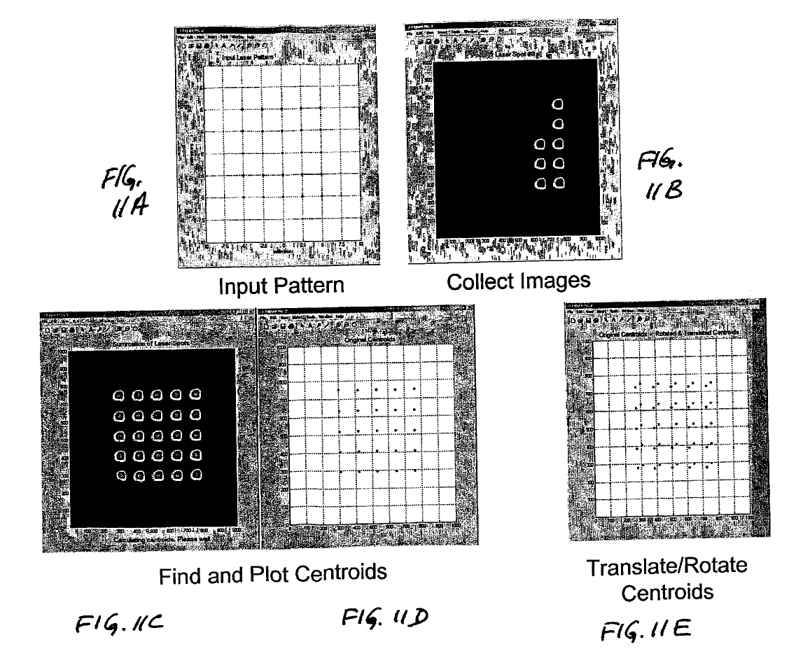

FIGS. 11A-11E indicate steps in a method for centering laser shots. FIG. 11A indicates the input pattern; FIG. 11B, image collection; FIG. 11C, the summation of the laser spots; FIG. 11D, plotting of the centroids; and FIG. 11E, translation and rotation of centroids.

The system 10 and method 100 described in the exemplary embodiments herein can be seen to provide multiple points for detecting more than just rotation errors as known previously. Unlike the typical paper ablation known in the art, a long-lived fluorescent material is used. The fluorescent uniformity is not critical. Pulse averaging can be performed for laser power variation, but is not necessary for geometric calculations. Another important feature is that individual laser spots can be viewed to detect laser motion at a single location, and the average laser shape can be analyzed to estimate shot shape and power.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

Having now described the invention, the construction, the operation and use of preferred embodiments thereof, and the advantageous new and useful results obtained thereby, the new and useful constructions, and reasonable mechanical equivalents thereof obvious to those skilled in the art, are set forth in the appended claims.

What is claimed is:

1. A system for assessing a performance of a laser system for use in corneal ablation, the system comprising:
a fluorescent indicator adapted to emit a first wavelength of light different from a second wavelength of light impinging thereon;
an optical system for directing a beam of laser shots onto the indicator in a plane of a cornea of an eye desired to be ablated and also onto a cornea positioned at the corneal plane;
a camera positioned to detect light reflected from the indicator; and
an analyzer in signal communication with the camera for calculating a difference between a detected light pattern from the camera and a predetermined ablation pattern desired to be made on the cornea, and for correcting the predetermined pattern to compensate for the calculated difference.

2. The system recited in claim 1, wherein the optical system comprises a partial mirror adapted to reflect the first and the second wavelength of light, the partial mirror oriented at approximately 45 degrees to the laser beam, and the cornea is positioned substantially normal to the laser beam.

3. The system recited in claim 2, wherein the partial mirror comprises an ultraviolet glass material.

4. The system recited in claim 2, wherein the partial mirror is coated with a material adapted to pass the laser beam and reflect visible fluorescence.

5. The system recited in claim 1, wherein the camera and the analyzer are adapted to operate faster than a shot rate of the laser.

6. The system recited in claim 5, wherein the analyzer is adapted to calculate an energy profile of a single laser shot.

7. The system recited in claim 6, wherein the analyzer is adapted to calculate an ablated volume of a unitary laser shot.

8. The system recited in claim 1, further comprising a controller in signal communication with the optical system for halting the beam of laser shots when a predetermined portion of the predetermined pattern has been completed, and wherein the analyzer is adapted to calculate a difference between the portion of the predetermined pattern that has been completed and the detected light pattern, and to perform the correcting compensation on a remaining portion of the predetermined pattern.

9. A method for assessing a performance of a laser system for use in corneal ablation, the method comprising the steps of:
directing a beam of laser shots onto a fluorescent indicator adapted to emit a first wavelength of light different from a second wavelength of light impinging thereon, the directing in a plane of a cornea of an eye desired to be ablated and also onto a cornea positioned at the corneal plane;
detecting light reflected from the indicator;
calculating a difference between a detected light pattern from the camera and a predetermined ablation pattern desired to be made on the cornea; and
correcting the predetermined pattern to compensate for the calculated difference.

10. The method recited in claim 9, wherein the directing step comprises reflecting the first and the second wavelength of light off a partial mirror oriented at approximately 45 degrees to the laser beam, and the cornea positioned substantially normal to the laser beam.

11. The method recited in claim 10, wherein the partial mirror comprises an ultraviolet glass material.

12. The method recited in claim 10, wherein the partial mirror is coated with a material adapted to pass the laser beam and reflect visible fluorescence.

13. The method recited in claim 9, wherein the detecting step operates faster than a shot rate of the laser.

14. The method recited in claim 13, wherein the calculating step comprises calculating an energy profile of a single laser shot.

15. The method recited in claim 14, wherein the calculating step comprises calculating an ablated volume of a unitary laser shot.

16. The method recited in claim 9, further comprising the step of halting the beam of laser shots when a predetermined portion of the predetermined pattern has been completed, and wherein the calculating step comprises calculating a difference between the portion of the predetermined pattern that has been completed and the detected light pattern, and the correcting step comprises performing the correcting compensation on a remaining portion of the predetermined pattern.
